(19) United States
(12) Patent Application Publication
(10) Pub. No.: US 2025/0238034 A1
(43) Pub. Date: Jul. 24, 2025

(54) CONTROL DEVICE

(71) Applicant: TOYOTA JIDOSHA KABUSHIKI KAISHA, Toyota-shi (JP)

(72) Inventors: Kento IWAHORI, Nagoya-shi (JP); Daiki Yokoyam, Miyoshi-shi (JP); Yasuhiro Saito, Toyoake-shi (JP)

(21) Appl. No.: 18/945,539

(22) Filed: Nov. 13, 2024

(30) Foreign Application Priority Data
Jan. 22, 2024 (JP) 2024-007123

(51) Int. Cl. G05D 1/648; B62D 65/18; G05D 1/656; G05D 107/70

(52) U.S. Cl. CPC G05D 1/648; B62D 65/18; G05D 1/656; G05D 2107/70

(57) ABSTRACT

The control device includes: an acquisition unit that acquires production plan information indicating a production plan of a moving body produced by self-propelled production that produces a moving body by using movement of the moving body by unmanned driving; a production facility that is used for self-propelled production by using the production plan information; a identifying unit that identifies a region in which at least one of a worker performing a particular task in self-propelled production is arranged; and an instruction unit that instructs the manager to move the working object to the region identified by the identifying unit.

### CROSS-REFERENCE TO RELATED APPLICATION

This application claims priority to Japanese Patent Application No. 2024-007123 filed on Jan. 22, 2024, incorporated herein by reference in its entirety.

### BACKGROUND

### 1. Technical Field

The present disclosure relates to a control device.

### 2. Description of Related Art

Conventionally, a vehicle that travels within a manufacturing system for producing vehicles autonomously or by remote control is known (Japanese Unexamined Patent Application Publication (Translation of PCT Application) No. 2017-538619 (JP 2017-538619 A)).

### SUMMARY

In some cases, a vehicle is produced by self-propelled production, in which a vehicle is produced by using traveling of the vehicle by unmanned driving. At the time of self-propelled production, there are cases in which production facilities such as a supply facility for supplying components to the vehicle, a storage facility in which tools used for assembling components to the vehicle are stored, an assembling facility for assembling components to the vehicle, and so forth, are used. However, a form deploying for the production facilities at the time of self-propelled production has yet to be proposed. Not only vehicles but also moving bodies have the same issue.

The present disclosure can be realized in the following aspects.

(1) According to one aspect of the present disclosure, a control device is provided. The control device includes
an acquisition unit that acquires production plan information indicating a production plan for a moving body that is produced by self-propelled production, for producing the moving body using movement of the moving body through unmanned driving,
an identifying unit that uses the production plan information to identify a region for deploying at least one work object of a production facility that is used in the self-propelled production, and a worker that executes a particular task in the self-propelled production, and
an instruction unit that instructs a manager to move the work object to the region identified by the identifying unit. According to this aspect, the work objects can be deployed in accordance with the production plan of the moving body at the time of the self-propelled production.

(2) According to another aspect of the present disclosure, a control device is provided. The control device includes
an acquisition unit that acquires production plan information indicating a production plan for a moving body that is produced by self-propelled production, for producing the moving body using movement of the moving body through unmanned driving,
an identifying unit that uses the production plan information to identify a region for deploying a production facility that is used for the self-propelled production and that is movable by the unmanned driving, and
a facility control unit that controls operation of the production facility such that the production facility moves to the region identified by the identifying unit. According to this aspect, the production facilities can be deployed in accordance with the production plan of the moving body at the time of the self-propelled production.

(3) The above form may further include
a detection unit that detects that the production plan has been changed, in which
when the detection unit detects that the production plan has been changed, the identifying unit identifies the region using the production plan information that is changed. According to this aspect, when the production plan of the moving body is changed, the region can be identified using the production plan information that is changed.

(4) The above form may further include
a deciding unit that decides a route when the moving body moves by the unmanned driving, and that is one or the other deciding unit of a first deciding unit that decides the route based on the region identified by the identifying unit, and a second deciding unit that decides the route using the production plan information before the region is identified by the identifying unit, in which
when the route is decided by the second deciding unit, the identifying unit identifies the region taking into consideration the route decided by the second deciding unit. According to this aspect, the route can be decided for when the moving body moves by the unmanned driving in the self-propelled production, in accordance with the production plan of the moving body.

(5) The above form may further include
a moving body control unit that controls operation of the moving body such that the moving body moves along the route decided by the deciding unit. According to this aspect, the operation of the moving body can be controlled such that the moving body moves along the route decided in accordance with the production plan of the moving body.

The present disclosure can be realized in various forms other than the above-described control device. For example, the present disclosure can be realized in the form of a production system including a control device, a production facility, and a moving body, a method for controlling deploying of a work object using the control device, a control device, a production facility, a moving body, and a production system manufacturing method, a control device, a production facility, a moving body, and a production system control method, a computer program for realizing the control method, a non-transitory recording medium storing the computer program, and so forth.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a system according to a first embodiment;

FIG. 2 is a flowchart illustrating a processing procedure of travel control of a vehicle according to the first embodiment;

FIG. 3 is a flowchart illustrating a method of controlling the arrangement of a work object according to the first embodiment;

FIG. 4 is a conceptual diagram illustrating an example of a method for producing a vehicle by self-propelled production;

FIG. 5 is a conceptual diagram showing an example of a method for producing a vehicle by conveyor-type production;

FIG. 6 is a block diagram illustrating a configuration of a system according to a second embodiment;

FIG. 7 is a flowchart showing a method of controlling the arrangement of a production facility according to the second embodiment;

FIG. 8 is a conceptual diagram illustrating another example of a vehicle production method;

FIG. 9 is a block diagram illustrating a configuration of a system according to a fourth embodiment; and

FIG. 10 is a flowchart illustrating a processing procedure of travel control of the vehicle according to the fourth embodiment.

### DETAILED DESCRIPTION OF EMBODIMENTS

### A. First Embodiment

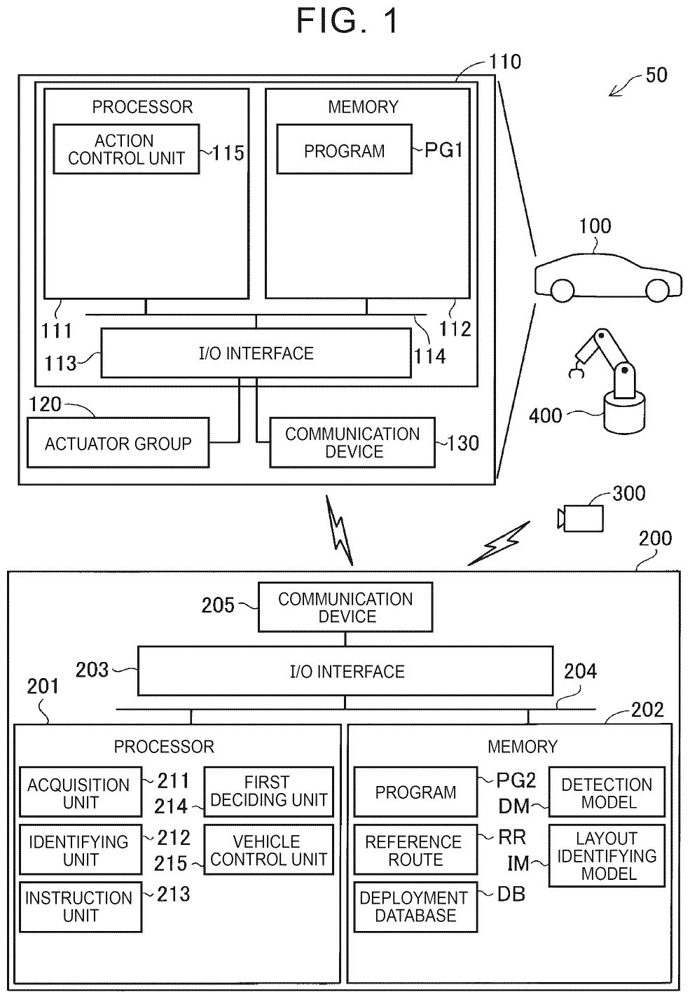

FIG. 1 is a block diagram illustrating a configuration of a system 50 according to a first embodiment. The system 50 is a system for producing a moving body by self-propelled production. “Self-propelled production” is a production system in which a moving body is produced by using “self-propelled conveyance” in which a moving body is conveyed by using movement of a moving body by unmanned driving. In the self-propelled conveyance, for example, at least a part of the conveyance of the moving body is realized by the self-propelled conveyance in a factory FC that manufactures the moving body. A configuration for realizing self-propelled conveyance is also referred to as a “vehicle remote control autonomous traveling conveyance system”. The system 50 includes one or more vehicles 100 as a moving body, a server 200, one or more external sensors 300, and one or more production facilities 400. In the present embodiment, the function of the “control device” in the present disclosure is realized by the server 200.

In the present disclosure, “moving body” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV), gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a task different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely decided from the outside of the vehicle 100, and “partial remote control” in which a part of the operations of the vehicle 100 is decided from the outside of the vehicle 100. Further, “autonomous control” includes “fully autonomous control” in which the vehicle 100 autonomously controls its operation without receiving any information from a device external to the vehicle 100, and “partially autonomous control” in which the vehicle 100 autonomously controls its operation using information received from a device external to the vehicle 100.

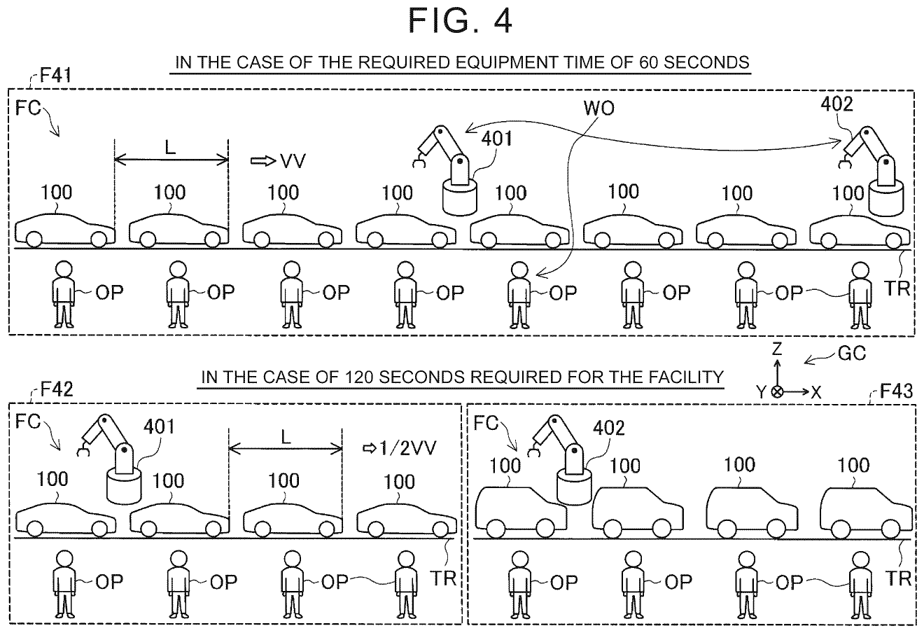

As shown in FIG. 4, which will be described later, the system 50 is used in a factory FC that manufactures the vehicles 100. The reference coordinate system of the factory FC is a global coordinate system GC, and any position in the factory FC can be represented by the coordinates of X, Y, Z in the global coordinate system GC. In the factory FC, a plurality of external sensors 300 are installed along the runway TR. The positions of the external sensors 300 in the factory FC are adjusted in advance.

The vehicle 100 includes a vehicle control device 110 for controlling each unit of the vehicle 100, an actuator group 120 including one or more actuators driven under the control of the vehicle control device 110, and a communication device 130 for wirelessly communicating with an external device such as the server 200. The actuator group 120 includes an actuator of a driving device for accelerating the vehicle 100, an actuator of a steering device for changing a traveling direction of the vehicle 100, and an actuator of a braking device for decelerating the vehicle 100.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 functions as the operation control unit 115 by executing the program PG1 stored in the memory 112.

The operation control unit 115 controls the actuator group 120 to cause the vehicle 100 to travel. The operation control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 by wireless communication, and can communicate with each external sensor 300 by wired communication or wireless communication. The processor 201 executes the program PG2 stored in the memory 202 to function as the acquisition unit 211, the identifying unit 212, the instruction unit 213, the first deciding unit 214, and the vehicle control unit 215.

The acquisition unit 211 acquires production plan information indicating a production plan of the vehicle 100 produced by the self-propelled production. The production plan information includes, for example, production target information and required time information. The production target information is information indicating a target number of production units for each vehicle type in a predetermined period. The production target information may include order information indicating a production order of each vehicle 100 or each vehicle type. The required time information is information indicating a required time related to the production of the vehicle 100. The required time information includes, for example, at least one of tact time information, process time information, and facility time information. The tact time information is information indicating the tact time for each vehicle 100. The tact time is a time spent for the production of one vehicle 100. The process time information is information indicating a required process time for each manufacturing process. The time required for a process is the time that can be spent in one manufacturing process. The facility time information is information indicating a required facility time for each production facility 400. The installation time is the time that can be spent when working with one production facility 400 for one vehicle 100.

The identifying unit 212 identifies a region in which at least one work object of the production facility 400 used for the self-propelled production and the worker performing the particular task in the self-propelled production is arranged, using the production plan information. The identifying unit 212 identifies a region in which a working object is to be arranged, for example, by referring to the arrangement database DB stored in the memory 202 of the server 200. The arrangement database DB is a database indicating the arrangement of the working objects according to various required times such as a tact time, a process required time, and a facility required time identified by the required time information. The identifying unit 212 may identify a region in which the working object is to be arranged by inputting the production plan-information to the layout identifying model IM using artificial intelligence. The layout identifying model IM is a learned machine learning model for outputting a region in which a working object is arranged when production planning information is inputted.

The instruction unit 213 instructs the manager to move the work object to the region identified by the identifying unit 212. For example, the instruction unit 213 displays the region identified by the identifying unit 212 on the display of the portable terminal owned by the manager. Thus, the manager can move the work object to the region identified by the identifying unit 212. The manager may be a worker or a person other than the worker.

The first deciding unit 214 decides a route when the vehicle 100 travels by unmanned driving based on the region identified by the identifying unit 212. The first deciding unit 214 stores the decided route in the memory 202 of the server 200 as the reference route RR.

The vehicle control unit 215 controls the operation of the vehicle 100 so that the vehicle 100 travels along the route decided by the first deciding unit 214, that is, the reference route RR. The vehicle control unit 215 acquires a detection result by the sensor, and generates a travel control signal for controlling the actuator group 120 of the vehicle 100 using the detection result. The vehicle control unit 215 transmits a travel control signal to the vehicle 100 to cause the vehicle 100 to travel by remote control.

The external sensor 300 is a sensor located outside the vehicle 100. The external sensor 300 in the present embodiment is a sensor that captures the vehicle 100 from the outside of the vehicle 100. The external sensor 300 includes a communication device (not shown), and can communicate with another device such as the server 200 by wired communication or wireless communication. Specifically, the external sensor 300 is constituted by a camera. The camera as the external sensor 300 captures an image of the vehicle 100 and outputs a captured image as a detection result.

The production facility 400 is a facility used when the vehicle 100 is produced. The production facility 400 is, for example, at least one of a supply facility that supplies a component to the vehicle 100, a storage facility that stores a tool used for assembling the component to the vehicle 100, and an assembling facility that assembles the component to the vehicle 100. Note that the type of the production facility 400 is not limited to the above. The production facility 400 may be, for example, a joining facility for joining components to the vehicle 100 by welding or the like, a painting facility for painting the vehicle 100, or an inspection facility for inspecting the function of the vehicle 100.

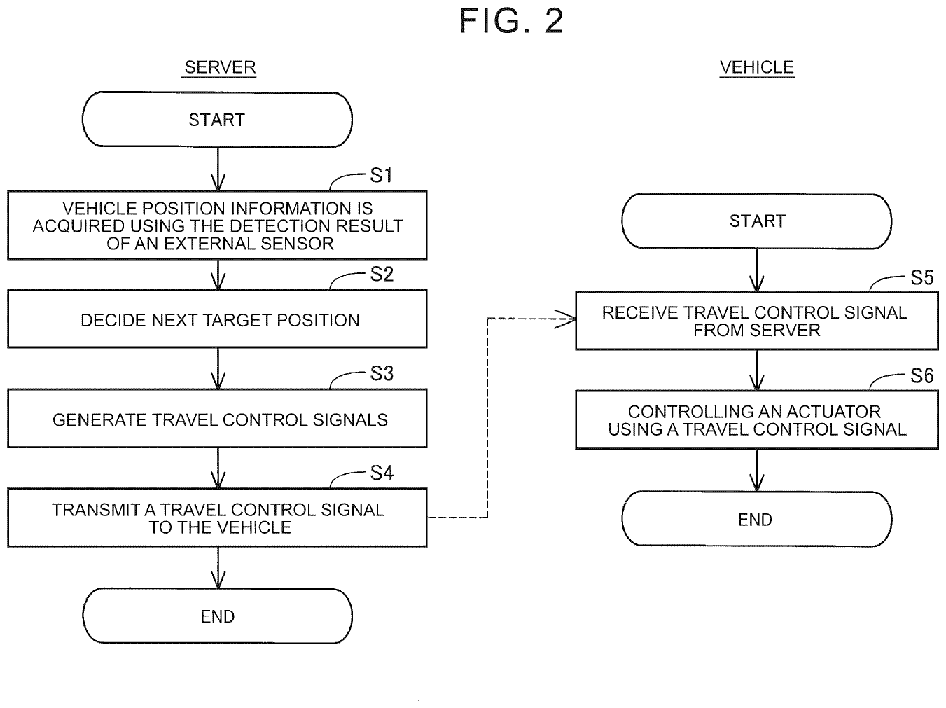

FIG. 2 is a flowchart illustrating a processing procedure of travel control of the vehicle 100 according to the first embodiment.

In S1, the processor 201 of the server 200 acquires the vehicle position information using the detection result outputted from the external sensor 300. The vehicle position information is position information that is a basis for generating a travel control signal. In the present embodiment, the vehicle position information includes the position and orientation of the vehicle 100 in the global coordinate system GC of the factory FC. Specifically, in S1, the processor 201 acquires vehicle-position information using captured images acquired from cameras that are the external sensors 300.

Specifically, in S1, for example, the processor 201 detects the outer shape of the vehicle 100 from the captured image, and calculates the coordinates of the positioning point of the vehicle 100 in the coordinate system of the captured image. The coordinate system of the captured image is a local coordinate system. The processor 201 obtains the position of the vehicle 100 by converting the calculated coordinates into coordinates in the global coordinate system GC. The outline of the vehicle 100 included in the captured image can be detected by, for example, inputting the captured image into a detection model DM using artificial intelligence. The detection model DM is prepared in the system 50 or outside the system 50, for example, and stored in the memory 202 of the server 200 in advance. Examples of the detection model DM include a learned machine learning model that is learned so as to realize one of semantic segmentation and instance segmentation. As the machine learning model, for example, a convolutional neural network (hereinafter referred to as a CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM. Further, the processor 201 can obtain the direction of the vehicle 100 by estimating the direction of the movement vector of the vehicle 100 calculated from the position change of the feature point of the vehicle 100 between the frames of the captured image using, for example, the optical flow method.

In S2, the processor 201 of the server 200 decides the target location to which the vehicles 100 should be heading next. In the present embodiment, the target position is represented by the coordinates of X, Y, Z in the global coordinate system GC. In the memory 202 of the server 200, reference route RR that is a route on which the vehicles 100 should travel is stored in advance. The route is represented by a node indicating a starting point, a node indicating a passing point, a node indicating a destination, and a link connecting the respective nodes. The processor 201 uses the vehicle position information and the reference route RR to decide the target position to which the vehicle 100 is to be directed next. The processor 201 decides the target position on the reference route RR ahead of the current position of the vehicles 100.

In S3, the processor 201 of the server 200 generates a travel control signal for causing the vehicle 100 to travel toward the decided target position. The processor 201 calculates the traveling speed of the vehicle 100 from the transition of the position of the vehicle 100, and compares the calculated traveling speed with the target speed. The processor 201 generally decides the acceleration so that the vehicle 100 accelerates when the travel speed is lower than the target speed, and decides the acceleration so that the vehicle 100 decelerates when the travel speed is higher than the target speed. In addition, the processor 201 decides the steering angle and the acceleration so that the vehicle 100 does not deviate from the reference route RR when the vehicle 100 is located on the reference route RR. When the vehicle 100 is not located on the reference route RR, in other words, when the vehicle 100 deviates from the reference route RR, the processor 201 decides the steering angle and the acceleration so that the vehicle 100 returns to the reference route RR.

In S4, the processor 201 of the server 200 transmits the generated travel control signal to the vehicles 100. The processor 201 repeats acquisition of vehicle position information, decision of a target position, generation of a travel control signal, transmission of a travel control signal, and the like at predetermined intervals.

In S5, the processor 111 of the vehicle 100 receives the travel control signal transmitted from the server 200. In S6, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 of the present embodiment, the vehicle 100 can be driven by remote control, and the vehicle 100 can be moved without using a conveyance facility such as a crane or a conveyor.

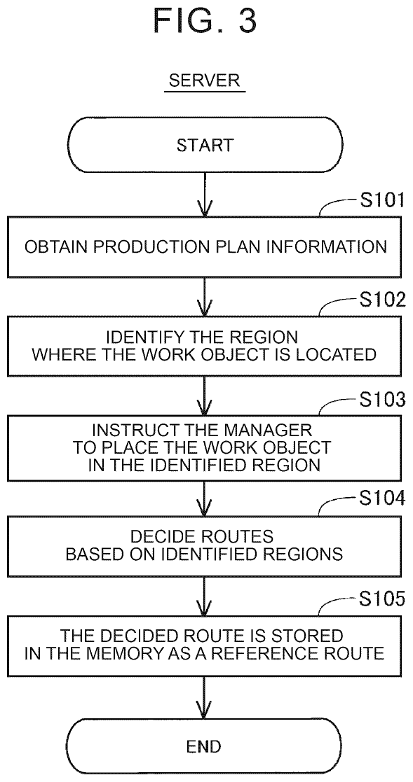

FIG. 3 is a flowchart illustrating a method of controlling the arrangement of a work object according to the first embodiment. In S101, the acquisition unit 211 acquires the production plan information. In S102, the identifying unit 212 identifies a region in which a working object is to be arranged by using the production plan information. In S103, the instruction unit 213 instructs the manager to arrange the working object in the region identified by the identifying unit 212. In S104, the first deciding unit 214 decides a route when the vehicle 100 travels by unmanned driving based on the region identified by the identifying unit 212. In S105, the first deciding unit 214 stores the decided route as the reference route RR in the memory 202 of the server 200.

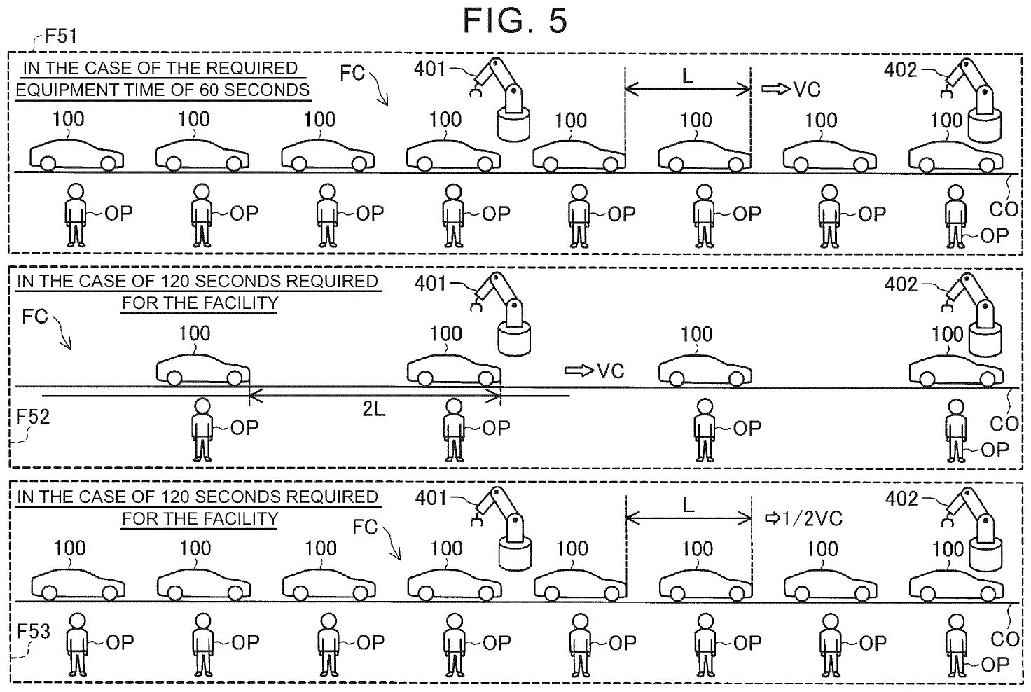

FIG. 4 is a conceptual diagram illustrating an example of a production method of the vehicle 100 by self-propelled production. FIG. 5 is a conceptual diagram illustrating an example of a method for producing the vehicle 100 by conveyor-type production. “Conveyor type production” is a production method in which a moving body is produced by using “conveyor conveyance” in which a moving body is conveyed by using a conveyor CO. The production method shown in FIG. 5 is a comparative example of the production method shown in FIG. 4.

In the conveyor-type production shown in FIG. 5, the conveyor CO is fixed at a predetermined position in the factory FC. Therefore, the production facility 400 is fixed at a predetermined position along the conveyor CO. The arrangement of the worker OP is decided according to the arrangement of the conveyor CO and the production facility 400. Therefore, in the case of conveyor-type production, the production space of the vehicle 100 is fixed. On the other hand, in the self-propelled production shown in FIG. 4, the vehicles 100 can be moved without using the conveyor CO. Therefore, it is possible to change the arrangement of the working object WO or change the traveling speed VV, the inter-vehicle distance L, and the route when the vehicle 100 travels by unmanned driving in accordance with the production plan of the vehicle 100. Specific examples are shown below.

In FIG. 4 and FIG. 5, in the assembling process, the assembling facility 401,402 assembles 12 components to the vehicle 100, and the assembling facility 401,402 assembles the components, and one worker OP performs a task with respect to the respective vehicles 100. The first assembling facility 401 and the second assembling facility 402 are articulated robots having the same function. In the example illustrated in FIGS. 4 and 5, the time required when each assembling facility 401,402 assembles one component to the vehicle 100 is 10 seconds.

In the case where the installation time of each assembling facility 401,402 is 60 seconds, the following configuration can be adopted, for example, in both the self-propelled production and the conveyor-type production. In this case, as shown in a first diagram F41 of FIG. 4 and a first diagram F51 of FIG. 5, a configuration can be adopted in which the first assembling facility 401 assembles six components to the vehicle 100, and the second assembling facility 402 assembles the remaining six components to the vehicle 100. In this configuration, in both of the self-propelled production and the conveyor-type production, there is no waiting time for each of the assembling facilities 401,402 to wait for a hand without executing the work.

In the case where the installation time of each assembling facility 401,402 is 120 seconds, the following configuration can be adopted in the conveyor-type production, for example. In this case, as shown in a second diagram F52 of FIG. 5, the conveyance speed VC of the vehicle 100 by the conveyor CO can be made the same as that in the case where the required time for the installation of each assembly facility 401,402 is 60 seconds, and the inter-vehicle distance L can be made twice as long as that in the case where the required time for the installation of each assembly facility 401,402 is 60 seconds. In this configuration, the number of vehicles 100 present at the place where the assembling process is performed is half the number of times that the installation time of each assembling facility 401,402 is 60 seconds. Therefore, the number of worker OP required for the assembling process can be halved when the required time of the assembling facilities 401,402 is 60 seconds. However, in this configuration, a waiting time of 60 seconds occurs after the six components are assembled to each of the assembling facilities 401,402.

In the case where the installation time of the assembling facility 401,402 is 120 seconds, the following configuration can be adopted in the conveyor-type production. In this case, as shown in a third diagram F53 of FIG. 5, it is also possible to adopt a configuration in which the inter-vehicle distance L is the same as that in the case where the installation required time of each assembly facility 401,402 is 60 seconds, and the conveyance speed VC of the vehicle 100 by the conveyor CO is halved in the case where the installation required time of each assembly facility 401,402 is 60 seconds. In this configuration, the number of worker OP required for the assembling process cannot be reduced, and moreover, the first assembling facility 401 and the second assembling facility 402 add up to a waiting time of 60 seconds.

On the other hand, in the case where the required time for the installation of each of the assembling facilities 401,402 is 120 seconds, the following configuration can be adopted in the self-propelled production. In this case, as shown in a second diagram F42 of FIG. 4, the inter-vehicle distance L can be set to be the same as the case where the required time for the installation of each of the assembling facilities 401,402 is 60 seconds, and the traveling speed VV of the vehicle 100 can be set to half the case where the required time for the installation of each of the assembling facilities 401,402 is 60 seconds. In this configuration, the first assembling facility 401 can assemble 12 components to the vehicle 100. Thus, the first assembling facility 401 can be operated without causing a standby time in the first assembling facility 401. Further, in this configuration, since the work by the second assembling facility 402 is not required, the number of vehicles 100 existing at the place where the assembling process is performed can be halved in the case where the time required for the facility of each assembling facility 401,402 is 60 seconds. In this way, the number of worker OP required for the assembling process and the manufacturing space required for the assembling process can be halved, respectively, when the installation time of the respective assembling facilities 401,402 is 60 seconds. As a result, as shown in a third diagram F43 of FIG. 4, the worker OP can be engaged in the production of another vehicle 100, or the free space can be used for the production of another vehicle 100 without being used in the assembling process, so that the worker OP and the production space can be effectively utilized. In addition, in this configuration, the second assembling facility 402 can be used for the production of another vehicle 100 or can be used for the work of another manufacturing process. As a result, the standby time of the assembling facility 401,402 can be reduced, and the operation rate of the assembling facility 401,402 can be improved.

According to the first embodiment, it is possible to identify a region in which the working object WO is arranged by using the production plan information. Then, the manager can be instructed to move the working object WO to the identified region. In this way, the working object WO can be arranged in accordance with the production planning of the vehicles 100 at the time of self-propelled production. Thus, the production efficiency of the vehicle 100 can be improved.

In addition, according to the first embodiment, it is possible to decide a route when the vehicle 100 travels by unmanned driving based on the region identified as the region in which the working object WO is to be arranged. That is, the route when the vehicle 100 travels by unmanned driving at the time of self-propelled production can be decided in accordance with the production plan of the vehicle 100.

Further, according to the first embodiment, the operation of the vehicle 100 can be controlled so that the vehicle 100 travels along a route decided based on the region identified as the region in which the working object WO is to be arranged.

### B. Second Embodiment

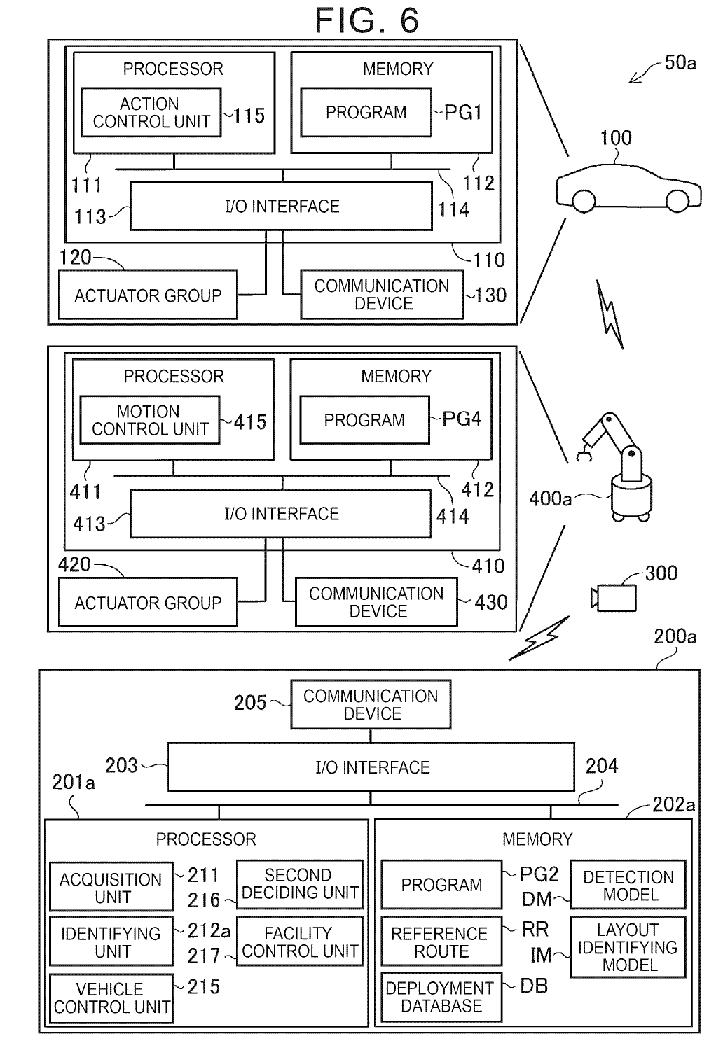

FIG. 6 is a block-diagram illustrating a configuration of a system 50a according to the second embodiment. In the present embodiment, 50a includes one or more vehicles 100, a server 200a, one or more external sensors 300, and one or more production facility 400a. In the present embodiment, the function of the “control device” in the present disclosure is realized by a server 200a. The configuration of 50a is the same as that of the first embodiment unless otherwise described. The same components as those in the first embodiment are denoted by the same reference numerals, and the description thereof is omitted.

The production facility 400a is configured to be movable by unmanned driving. The production facility 400a includes a facility control device 410, an actuator group 420 including one or more actuators driven under the control of the facility control device 410, and a communication device 430 for wirelessly communicating with an external device such as a server 200a. The actuator group 420 includes an actuator of a driving device for accelerating the production facility 400a, an actuator of a steering device for changing the traveling direction of the production facility 400a, and an actuator of a braking device for decelerating the production facility 400a.

The facility control device 410 includes a computer including a processor 411, a memory 412, an input/output interface 413, and an internal bus 414. The processor 411, the memory 412, and the input/output interface 413 are bidirectionally communicably connected via an internal bus 414. An actuator group 420 and a communication device 430 are connected to the input/output interface 413. The processor 411 functions as the motion control unit 415 by executing the program PG4 stored in the memory 412.

The motion control unit 415 moves the production facility 400a by controlling the actuator group 420. The motion control unit 415 may control the actuator group 420 by using the motion control signal received from the server 200a to move the production facility 400a. The motion control signal is a control signal for driving the production facility 400a. In the present embodiment, the motion control signal includes the acceleration and the steering angle of the production facility 400a as parameters. In other embodiments, the motion control signal may include the velocity of the production facility 400a as a parameter in place of or in addition to the acceleration of the production facility 400a.

The server 200a includes a computer including a processor 201a, a memory 202a, an input/output interface 203, and an internal bus 204. The processor 201a executes the program PG2 stored in the memory 202a to function as the acquisition unit 211, the identifying unit 212a, the vehicle control unit 215, the second deciding unit 216, and the facility control unit 217.

The second deciding unit 216 decides a route on which the vehicle 100 travels by the unmanned driving, using the production planning information, prior to the region in which the production facility 400a is arranged being identified by the identifying unit 212a. The second deciding unit 216 stores the decided route as the reference route RR in the memory 202a of the server 200a.

When the route is decided by the second deciding unit 216, the identifying unit 212a identifies a region in which the production facility 400a is to be arranged, taking into account the route decided by the second deciding unit 216.

The facility control unit 217 controls the operation of the production facility 400a so that the production facility 400a moves to the region identified by the identifying unit 212a. The facility control unit 217 acquires a detection result by the sensor, generates a motion control signal for controlling the actuator group 420 of the production facility 400a by using the detection result, and transmits a motion control signal to the production facility 400a, thereby moving the production facility 400a by remote control.

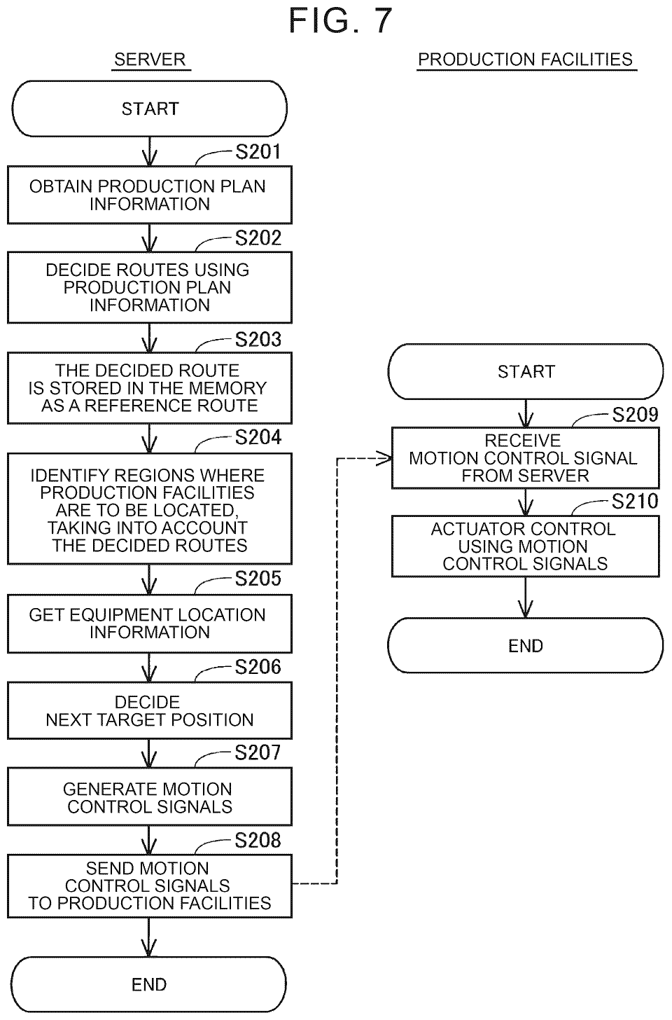

FIG. 7 is a flow chart illustrating an arrangement control process of the production facility 400a according to the second embodiment. In S201, the acquisition unit 211 of the server 200a acquires the production plan information. In S202, the second deciding unit 216 decides a route when the vehicle 100 travels by unmanned driving, using the production plan information. In S203, the second deciding unit 216 stores the decided route in the memory 202a of the server 200a as the reference route RR. In S204, the identifying unit 212a identifies a region in which the production facility 400a is to be arranged, taking into consideration the route decided by the second deciding unit 216. In S205, the facility control unit 217 acquires facility position information using captured images acquired from cameras that are external sensors 300. In S206, the facility control unit 217 uses the facility location information and the region identified by the identifying unit 212a to decide the target location to which the production facility 400a should be directed next. In S207, the facility control unit 217 generates motion control signals for moving the production facility 400a toward the decided target position. At S208, the facility control unit 217 transmits the generated motion control signal to the production facility 400a. In S209, the motion control unit 415 of the production facility 400a receives motion control signals transmitted from the server 200a. In S210, the motion control unit 415 controls the actuator group 420 by using the received motion control signal to move the production facility 400a at the accelerations and steering angles represented by the motion control signal.

According to the second embodiment, it is possible to identify a region in which the production facility 400a that is movable by the unmanned driving is arranged by using the production planning information. Then, the operation of the production facility 400a can be controlled so that the production facility 400a moves to the identified region.

Further, according to the second embodiment, it is possible to decide a route when the vehicle 100 travels by unmanned driving using the production planning information, prior to the region in which the production facility 400a is arranged being identified by the identifying unit 212a. Then, the operation of the vehicle 100 can be controlled so that the vehicle 100 travels along the route decided by using the production plan information.

In addition, according to the second embodiment, it is possible to identify a region in which the production facility 400a is arranged, taking into consideration a route when the vehicles 100 travel by unmanned driving.

### C. Third Embodiment

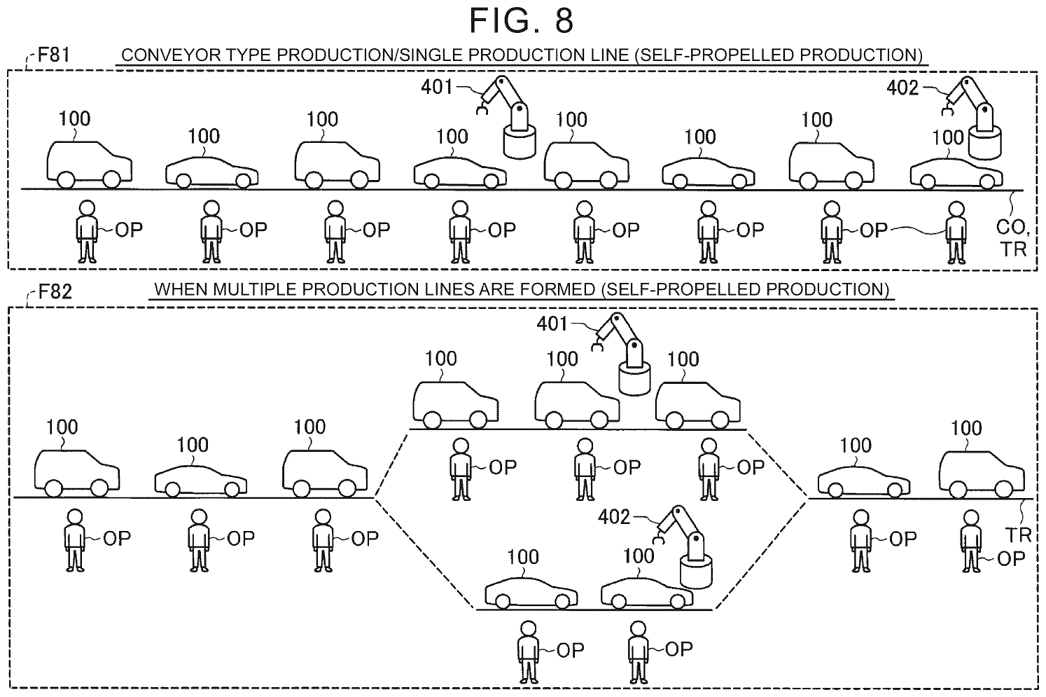

FIG. 8 is a conceptual diagram illustrating another example of a production method of the vehicle 100. FIG. 8 illustrates an example in which, in an assembling process in the case of mixed flow production, the assembling facility 401,402 assembles a number and types of components corresponding to the vehicle type to the vehicle 100 by assembling methods corresponding to the vehicle type, and one worker OP performs an operation on the respective vehicles 100.

In a case where a plurality of vehicles 100 of different vehicle types are produced in a mixed flow, for example, the number of components to be assembled to the vehicle 100 in the assembling process may be different for each vehicle type. As a result, the amount of work in the same manufacturing process may be different for each vehicle type. In a case where the amount of work in the same manufacturing process is different for each vehicle type, the following problem may arise in a case where the vehicle 100 is produced by conveyor-type production. In this case, as shown in a first diagram F81 of FIG. 8, since the required time of the process differs for each vehicle type according to the workload for each vehicle type, a waiting time may occur in the assembling facility 401,402. In addition, in a case where a plurality of vehicles 100 of different vehicle types are produced in a mixed flow, for example, in an assembling process, the types of components to be assembled to the vehicle 100 may be different for each vehicle type, or the assembling method of the components to the vehicle 100 may be different. As a result, the work contents in the same manufacturing process may be different for each vehicle type. In a case where the task contents in the same manufacturing process are different for each vehicle type, the following problem may arise in a case where the vehicle 100 is produced by conveyor-type production. In this case, as illustrated in the first diagram F81 of FIG. 8, the assembling facility 401,402 needs to perform a different operation according to the task content of each vehicle type, and the control of the assembling facility 401,402 may be complicated. Such a problem is also common in the case of producing the vehicle 100 by self-propelled production, and in the case of producing the vehicle 100 while the vehicle 100 is driven so as to form a single production line.

Therefore, as shown in a second diagram F82 of FIG. 8, at least a part of the route when the vehicle 100 travels by unmanned driving may be parallelized according to the vehicle type. In this case, for example, the acquisition unit 211 acquires the production plan information including the work information. The work information is information indicating the work amount and the work content of each manufacturing process executed in the production process of the vehicle 100 for each vehicle type. The deciding unit 214,216 decides a route when the vehicle 100 travels by unmanned driving so as to form a plurality of production lines by traveling on a route different for each vehicle type. The identifying units 212, 212a identify the type of the assembling facility 401,402 and the region in which the assembling facility 401,402 is arranged so that the assembling facility 401,402 is arranged according to the task content of each vehicle type. Even when the vehicle types are different, the work amount and the work content in the same manufacturing process may be the same. In this case, at least a part of the route when the vehicle 100 travels by the unmanned driving may be parallelized for each vehicle type group grouped according to the work amount and the work content in the manufacturing process.

According to the third embodiment, when a plurality of vehicles 100 of different vehicle types are produced in a mixed flow, the route when the vehicle 100 travels by unmanned driving can be made different according to the work amount in the manufacturing process. Then, the production facilities 400, 400a can be arranged along a route when the vehicles 100 travel by unmanned driving. This can reduce the possibility of a standby period occurring in the production facilities 400, 400a.

Further, according to the third embodiment, when a plurality of vehicles 100 of different vehicle types are produced in a mixed flow, the route when the vehicle 100 travels by unmanned driving can be made different according to the work content in the manufacturing process. Then, the production facilities 400, 400a can be arranged along a route when the vehicles 100 travel by unmanned driving. Thus, it is possible to avoid complicated control of the production facilities 400, 400a.

Further, according to the third embodiment, when a plurality of vehicles 100 of different vehicle types are produced in a mixed flow, the range of the production spaces parallelized in accordance with at least one of the vehicle type and the vehicle type group can be flexibly changed in accordance with the target number of production units of the vehicle type or the vehicle type group.

### D. Fourth Embodiment

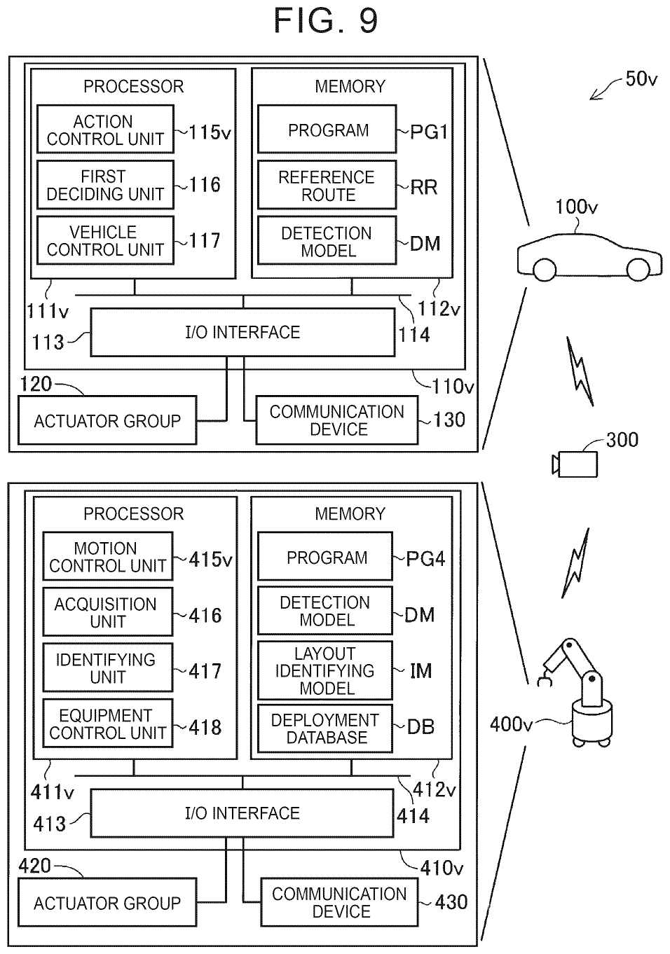

FIG. 9 is a block diagram illustrating a configuration of a system 50v according to a fourth embodiment. This embodiment differs from the above-described embodiments in that the system 50v does not include the server 200. The vehicle 100v according to the present embodiment can travel by autonomous control of the vehicle 100v. The production facility 400v in the present embodiment is movable by autonomous control of the production facility 400v. In the present embodiment, the function of the “control device” in the present disclosure is realized by the vehicle control device 110v and the facility control device 410v. Other configurations are the same as those of the second embodiment unless otherwise described. The same components as those in the above-described embodiments are denoted by the same reference numerals, and the description thereof is omitted.

In the present embodiment, the processor 111v of the vehicle control device 110v functions as the first deciding unit 116, the vehicle control unit 117, and the operation control unit 115v by executing the program PG1 stored in the memory 112v. The first deciding unit 116 acquires arrangement information indicating a region identified as a region in which the working object WO is arranged. The first deciding unit 116 decides a route on which the vehicle 100v travels by unmanned driving based on the arrangement information. The first deciding unit 116 stores the decided route as the reference route RR in the memory 112v of the vehicle control device 110v. The vehicle control unit 117 controls the operation of the vehicle 100 so that the vehicle 100 travels along the route decided by the first deciding unit 214, that is, the reference route RR. The vehicle control unit 117 acquires a detection result by the sensor, and generates a travel control signal for controlling the actuator group 120 of the vehicle 100v using the detection result. The operation control unit 115v operates the actuator group 120 by using the travel control signal generated by the vehicle control unit 117, thereby causing the vehicle 100v to travel by autonomous control.

In the present embodiment, the processor 411v of the facility control device 410v functions as the acquisition unit 416, the identifying unit 417, the facility control unit 418, and the motion control unit 415v by executing the program PG4 stored in the memory 412v. The acquisition unit 416 acquires production plan information. The identifying unit 417 identifies a region in which the production facility 400v that is itself is to be arranged. The facility control unit 418 controls the operation of the production facility 400v so that the production facility 400v moves to the region identified by the identifying unit 417. The facility control unit 418 acquires a detection result by the sensor, and generates a motion control signal for controlling the actuator group 420 of the production facility 400v using the detection result. The motion control unit 415v operates the actuator group 420 by using the motion control signal generated by the facility control unit 418, thereby moving the production facility 400v by autonomous control.

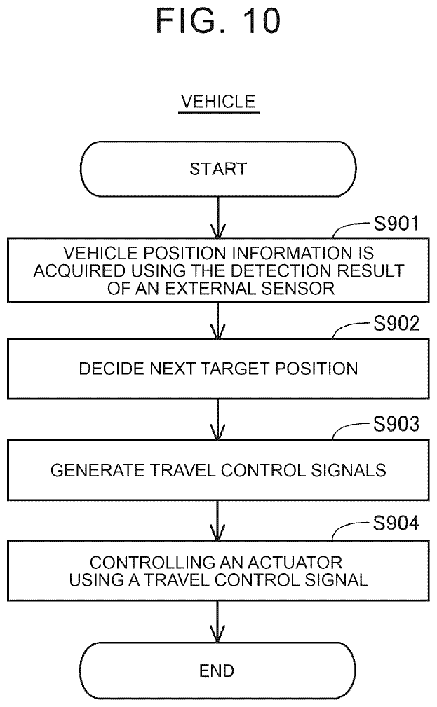

FIG. 10 is a flow chart showing a process sequence of travel control of the vehicle 100v according to the fourth embodiment. In S901, the processor 111v of the vehicle control device 110v acquires the vehicle position information using the detection result outputted from the camera as the external sensor 300. In S902, the processor 111v decides the target position to which the vehicle 100v should be headed next. In S903, the processor 111v generates a travel control signal for causing the vehicle 100v to travel toward the decided target position. In S904, the processor 111v controls the actuator group 120 by using the generated travel control signal, thereby causing the vehicle 100v to travel in accordance with the parameter represented by the travel control signal. The processor 111v repeats acquiring the vehicle position information, deciding the target position, generating the travel control signal, and controlling the actuator at a predetermined cycle. According to the system 50v of the present embodiment, the vehicle 100v can be driven by the autonomous control of the vehicle 100v without remotely controlling the vehicle 100v by the server 200.

According to the fourth embodiment, the production facility 400v can be arranged in a region corresponding to the production planning of the vehicle 100v by autonomous control of the production facility 400v without remotely controlling the production facility 400v by the server 200.

### E. Other Embodiments

(E1) The control device may further include a detection unit configured to detect that a production plan of the vehicles 100, 100v has been changed. The production planning is changed, for example, when production of a particular vehicle type is stopped due to recall or failure, when it becomes difficult to ship vehicles 100, 100v to a particular destination, or when an order of a particular vehicle type is newly started and the order of the particular vehicle type is increased. When the detection unit detects that the production plan of the vehicles 100, 100v has been changed, the identifying units 212, 212a, 417 may identify a region in which the working object WO is arranged by using the changed production plan information. With this configuration, when the production plan of the vehicles 100, 100v is changed, the arrangement of the working object WO can be identified in accordance with the production plan after the change. In addition, when the detection unit detects that the production plan of the vehicles 100, 100v has been changed, the second deciding unit 216 may decide the route when the vehicles 100, 100v travel by the unmanned driving using the changed production plan information. With such a configuration, when the production plan of the vehicles 100, 100v is changed, the route when the vehicles 100, 100v travel by the unmanned driving can be decided in accordance with the production plan after the change. This can further improve the productivity of the vehicles 100, 100v.

(E2) At least some of the functions of the control device may be implemented by the vehicle control devices 110, 110v or may be implemented by the facility control devices 410, 410v.

(E3) In each of the above-described embodiments, the external sensor 300 is not limited to a camera, and may be, for example, a distance measuring device. The distance measuring device is, for example, a LiDAR (Light Detection and Ranging). In this case, the detection result outputted by the external sensor 300 may be three-dimensional point cloud data representing the vehicles 100, 100v and the production facilities 400, 400a, 400v. In this case, the servers 200, 200a, the vehicles 100, 100v, and the production facilities 400, 400a, 400v may acquire the vehicle position information and the facility position information by template matching using the three-dimensional point cloud data as detection results and the reference point cloud data prepared in advance.

(E4) In the second embodiment, the server 200a performs a process from acquiring the facility position information to generating the motion control signal. On the other hand, at least a part of the process from the acquisition of the facility position information to the generation of the motion control signal may be executed by the production facility 400a. For example, the following forms (1) to (3) may be used.

(1) The server 200a may acquire the facility position information, decide a target position to which the production facility 400a should be directed next, and generate a route from the current position of the production facility 400a represented in the acquired facility position information to the target position. The server 200a may generate a route to a target position between the current location and the destination, or may generate a route to the destination. The server 200a may transmit the generated route to the production facility 400a. The production facility 400a may generate a motion control signal so that the production facility 400a moves on a route received from the server 200a, and control the actuator group 420 using the generated motion control signal.

(2) The server 200a may acquire the facility location information and transmit the acquired facility location information to the production facility 400a. The production facility 400a may decide a target position to which the production facility 400a should be directed next, generate a route from the current position of the production facility 400a represented in the received facility position information to the target position, generate a motion control signal such that the production facility 400a travels on the generated route, and control the actuator group 420 using the generated motion control signal.

(3) In the forms (1) and (2), a mounted sensor may be mounted on the production facility 400a, and a detection result output from the mounted sensor may be used for at least one of generation of a route and generation of a travel control signal. The mounted sensor is a sensor mounted on the production facility 400a. The mounted sensor may include, for example, a sensor that detects a motion state of the production facility 400a, a sensor that detects an operation state of each unit of the production facility 400a, and a sensor that detects an environment around the production facility 400a. Specifically, the mounted sensor may include, for example, a camera, a LiDAR, a millimeter-wave radar, an ultrasonic sensor, a GPS sensor, an acceleration sensor, a gyrosensor, and the like. For example, in the form (1), the server 200a may acquire the detection result of the mounted sensor and reflect the detection result of the mounted sensor in the route when generating the route. In the form (1), the production facility 400a may acquire the detection result of the mounted sensor and reflect the detection result of the mounted sensor in the motion control signal when generating the motion control signal. In the form (2), the production facility 400a may acquire the detection result of the mounted sensor and reflect the detection result of the mounted sensor in the route when generating the route. In the form (2), the production facility 400a may acquire the detection result of the mounted sensor and reflect the detection result of the mounted sensor in the motion control signal when generating the motion control signal.

(E5) In the fourth embodiment, a mounted sensor may be mounted on the production facility 400v, and a detection result output from the mounted sensor may be used for at least one of generation of a route and generation of a motion control signal. For example, the production facility 400v may acquire the detection result of the mounted sensor and reflect the detection result of the mounted sensor in the route when generating the route. The production facility 400v may acquire a detection result of the mounted sensor and reflect the detection result of the mounted sensor in the motion control signal when generating the motion control signal.

(E6) In the fourth embodiment, the production facility 400v acquires the facility position information using the data detected by the external sensor 300. On the other hand, an on-board sensor is mounted on the production facility 400v, and the production facility 400v may acquire the facility position information using the detection result of the on-board sensor, decide a target position to which the production facility 400v should be directed next, generate a route from the current position of the production facility 400v represented in the acquired facility position information to the target position, generate a motion control signal for moving the generated route, and control the actuator group 420 using the generated motion control signal. In this case, the production facility 400v can be moved without using the detection result of the external sensor 300 at all. It should be noted that all the functional configurations of the system 50v may be provided in the production facility 400v. That is, the process implemented by the system 50v may be implemented by the production facility 400v alone.

(E7) In the second embodiment, the server 200a automatically generates motion control signals to be transmitted to the production facility 400a. On the other hand, the server 200a may generate motion control signals to be transmitted to the production facility 400a in accordance with an operation of an external operator located outside the production facility 400a. For example, an external operator may operate a control device including a display for displaying captured images outputted from the external sensor 300, an operation device for remotely controlling the production facility 400a, and a communication device for communicating with the server 200a through wired communication or wireless communication, and the server 200a may generate a motion control signal corresponding to an operation applied to the control device.

(E8) In the first embodiment to the third embodiment, the servers 200, 200a perform a process from acquiring the vehicle position information to generating the travel control signal. On the other hand, at least a part of the processing from the acquisition of the vehicle position information to the generation of the travel control signal may be executed by the vehicle 100. For example, the following forms (1) to (3) may be used.

(1) The servers 200, 200a may acquire vehicle position information, decide a target position to which the vehicle 100 should be heading next, and generate a route from the current position of the vehicle 100 represented by the acquired vehicle position information to the target position. The servers 200, 200a may generate a route to a target position between the current location and the destination, or may generate a route to the destination. The servers 200, 200a may transmit the generated route to the vehicles 100. The vehicle 100 may generate a travel control signal so that the vehicle 100 travels on a route received from the servers 200, 200a, and control the actuator group 120 using the generated travel control signal.

(2) The servers 200, 200a may acquire the vehicle position information and transmit the acquired vehicle position information to the vehicle 100. The vehicle 100 may decide a target position to which the vehicle 100 should be directed next, generate a route from the current position of the vehicle 100 represented by the received vehicle position information to the target position, generate a travel control signal so that the vehicle 100 travels on the generated route, and control the actuator group 120 using the generated travel control signal.

(3) In the above forms (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the above form (1), the servers 200, 200a may acquire the detection result of the internal sensor and reflect the detection result of the internal sensor in the route when generating the route. In the form (1), the vehicle 100 may acquire the detection result of the internal sensor and reflect the detection result of the internal sensor in the travel control signal when generating the travel control signal. In the form (2), the vehicle 100 may acquire the detection result of the internal sensor and reflect the detection result of the internal sensor in the route when generating the route. In the form (2), the vehicle 100 may acquire the detection result of the internal sensor and reflect the detection result of the internal sensor in the travel control signal when generating the travel control signal.

(E9) In the fourth embodiment, an internal sensor may be mounted on the vehicle 100v, and a detection result outputted from the internal sensor may be used for at least one of generation of a route and generation of a travel control signal. For example, the vehicle 100v may acquire the detection result of the internal sensor and reflect the detection result of the internal sensor in the route when generating the route. The vehicle 100v may acquire the detection result of the internal sensor and reflect the detection result of the internal sensor in the travel control signal when generating the travel control signal.

(E10) In the fourth embodiment, the vehicle 100v acquires the vehicle position information using the detection result of the external sensor 300. On the other hand, an internal sensor is mounted on the vehicle 100v, and the vehicle 100v may acquire the vehicle position information using the detection result of the internal sensor, decide a target position to which the vehicle 100v should be directed next, generate a route from the current position of the vehicle 100v represented in the acquired vehicle position information to the target position, generate a travel control signal for traveling on the generated route, and control the actuator group 120 using the generated travel control signal. In this case, the vehicle 100v can travel without using the detection result of the external sensor 300 at all. The vehicle 100v may acquire the target arrival time and the traffic jam information from the outside of the vehicle 100v and reflect the target arrival time and the traffic jam information on at least one of the route and the travel control signal. In addition, all the functional configurations of the system 50v may be provided in the vehicle 100v. That is, the process implemented by the system 50v may be implemented by the vehicle 100v alone.

(E11) In the first embodiment, the servers 200, 200a automatically generate a travel control signal to be transmitted to the vehicles 100. On the other hand, the servers 200, 200a may generate a travel control signal to be transmitted to the vehicle 100 in accordance with an operation of an external operator located outside the vehicle 100. For example, an external operator may operate a control device including a display for displaying captured images outputted from the external sensor 300, a steering for remotely operating the vehicle 100, an accelerator pedal, a brake pedal, and a communication device for communicating with the servers 200, 200a through wired communication or wireless communication, and the servers 200, 200a may generate a travel control signal corresponding to an operation applied to the control device.

(E12) In the above-described embodiments, the vehicles 100, 100v may have a configuration that is movable by unmanned driving, and may be, for example, in the form of a platform that includes the configuration described below. Specifically, the vehicles 100, 100v may include at least vehicle control devices 110, 110v and an actuator group 120 in order to perform three functions of “running”, “turning”, and “stopping” by unmanned driving. When the vehicles 100, 100v acquire information from the outside for unmanned driving, the vehicles 100, 100v may further include a communication device 130. That is, in the vehicles 100, 100v that are movable by unmanned driving, at least a part of an interior component such as a driver's seat or a dashboard may not be mounted, at least a part of an exterior component such as a bumper or a fender may not be mounted, and a body shell may not be mounted. In this case, the remaining components such as the body shell may be mounted on the vehicles 100, 100v until the vehicles 100, 100v are shipped from the factory FC, or the remaining components such as the body shell may be mounted on the vehicles 100, 100v after the vehicles 100, 100v are shipped from the factory FC while the remaining components such as the body shell are not mounted on the vehicles 100, 100v. Each component may be attached from any direction, such as the upper, lower, front, back, right or left side of the vehicles 100, 100v, may be attached from the same direction, each may be attached from different directions. It should be noted that the position decision can be performed in the same manner as in the vehicles 100, 100v according to the first embodiment.

(E13) The vehicles 100, 100v may be manufactured by combining a plurality of modules. Modules refer to units composed of one or more components grouped according to the configuration and function of the vehicles 100, 100v. For example, the platform of the vehicles 100, 100v may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. Also, in addition to or instead of the platform, parts of the vehicles 100, 100v that differ from the platform may be modularized. Further, the various modules may include any exterior parts such as bumpers and grills, and any interior parts such as sheets and consoles. In addition, the present disclosure is not limited to vehicles 100, 100v, and a moving body of any aspect may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasting or megacasting. By using the gigacasting, each part of the moving body, which has been conventionally formed by joining a plurality of parts, can be formed as one part. For example, the front module, the central module, and the rear module described above may be manufactured using gigacasting.

The present disclosure is not limited to each of the above embodiments, and can be realized by various configurations without departing from the spirit thereof. For example, the technical features of the embodiments corresponding to the technical features in the respective forms described in the Summary can be appropriately replaced or combined in order to solve some or all of the above-described problems or to achieve some or all of the above-described effects. Further, when the technical features are not described as essential in the present identification, these can be deleted as appropriate.

What is claimed is:

1. A control device comprising:
an acquisition unit that acquires production plan information indicating a production plan for a moving body that is produced by self-propelled production, for producing the moving body using movement of the moving body through unmanned driving;
an identifying unit that uses the production plan information to identify a region for deploying at least one work object of a production facility that is used in the self-propelled production, and a worker that executes a particular task in the self-propelled production; and
an instruction unit that instructs a manager to move the work object to the region identified by the identifying unit.

2. A control device comprising:
an acquisition unit that acquires production plan information indicating a production plan for a moving body that is produced by self-propelled production, for producing the moving body using movement of the moving body through unmanned driving;
an identifying unit that uses the production plan information to identify a region for deploying a production facility that is used for the self-propelled production and that is movable by the unmanned driving; and
a facility control unit that controls operation of the production facility such that the production facility moves to the region identified by the identifying unit.

3. The control device according to claim 1, further comprising a detection unit that detects that the production plan has been changed, wherein when the detection unit detects that the production plan has been changed, the identifying unit identifies the region using the production plan information that is changed.

4. The control device according to claim 2, further comprising a detection unit that detects that the production plan has been changed, wherein when the detection unit detects that the production plan has been changed, the identifying unit identifies the region using the production plan information that is changed.

5. The control device according to claim 1, further comprising a deciding unit that decides a route when the moving body moves by the unmanned driving, and that is one or the other deciding unit of
a first deciding unit that decides the route based on the region identified by the identifying unit, and
a second deciding unit that decides the route using the production plan information before the region is identified by the identifying unit, wherein
when the route is decided by the second deciding unit, the identifying unit identifies the region taking into consideration the route decided by the second deciding unit.

6. The control device according to claim 2, further comprising a deciding unit that decides a route when the moving body moves by the unmanned driving, and that is one or the other deciding unit of
a first deciding unit that decides the route based on the region identified by the identifying unit, and
a second deciding unit that decides the route using the production plan information before the region is identified by the identifying unit, wherein
when the route is decided by the second deciding unit, the identifying unit identifies the region taking into consideration the route decided by the second deciding unit.

7. The control device according to claim 5, further comprising a moving body control unit that controls operation of the moving body such that the moving body moves along the route decided by the deciding unit.

8. The control device according to claim 6, further comprising a moving body control unit that controls operation of the moving body such that the moving body moves along the route decided by the deciding unit.
